(19) United States
(12) Patent Application Publication
(10) Pub. No.: US 2008/0066306 A1
(43) Pub. Date: Mar. 20, 2008

(54) ELECTRICALLY CONDUCTIVE FABRIC JUMPERS

(76) Inventor: Allen J. Bernardini, Morris, CT (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/566,364

(22) Filed: Dec. 4, 2006

Related U.S. Application Data
(60) Provisional application No. 60/825,996, filed on Sep. 18, 2006.

(51) Int. Cl. H01R 43/02; H01B 1/00

(52) U.S. Cl. 29/877; 174/70 R; 29/884

(57) ABSTRACT

Disclosed is a heat staking process using a configuration to join two conductive yarn traces or pads by piercing them with a thermo plastic stud shaped somewhat like a rivet with a pointed post to pierce the fabrics. A properly designed tool can be lowered to meet the pointed tip of the stud and by using the proper heat and proper compression will join the two fabric pieces mechanically and electrically. The heat and compression formed stud 50 will provide mechanical strength and actually seal the connection if so required.

### RELATED APPLICATION

The present application is based on, and claims priority from, U.S. Application No. 60/825,996, filed Sep. 18, 2006, the disclosure of which is hereby incorporated by reference herein in its entirety.

### FIELD OF THE INVENTION

The present invention is directed to the field of electrical connectors, and more specifically, the field of electrical connectors to connect across conductive fabric sections. Even more specifically, the present invention is directed to jumpers from one conductive fabric section to another in order to complete an electrical circuit across seams, patches, hems and the like.

### BACKGROUND OF THE INVENTION

It is recognized in the art that there is a need for electrical connections—in specific—jumpers from one conductive fabric section to another in order to complete an electrical circuit across seams, patches, hems and the like. There is also a need to terminate two or more electrically conductive yarns or traces to complete a circuit. The present invention provides a solution to this technical dilemma.

Until recently, clothing which incorporates electronics, used fine wires sewn in or weaved into the fabric of the garment for routing of the electrical signals. While functional, this process is expensive, time consuming to do, and the wires are difficult to terminate except by hard wiring or with electrical connectors which are bulky, fragile and non washable or not dryable in machines.

Recent developments in the ability to produce electrically conductive yarns and threads have enabled a whole new industry of clothing to contain necessary circuitry for biological, chemical, physical and intrusion sensors. These yarns can be woven or sewed into a fabric or an article of clothing to allow a conductive path thus eliminating the need for stiff, fragile wires to be woven, inserted or applied to provide these functions. The yarns can be integrated into the design of the fabric such that their presence is not evident.

There is an increasing interest in this type of clothing for military and civilian applications. For example—vital signs sensors which include heart rate, respiration, dehydration, temperature, chemical and biological warfare sensors plus a host of sport and entertainment applications which include some of the same, plus communications, heaters, IPODs, computers, GPS, radio, tape recorders, wearable TV's, etc.

At present, to provide a circuit path from—for example, the collar or sleeve of a garment to a pocket near the waist of the wearer, there has to be a continuous woven path of fabric such that there are no interruptions in the weave of the fabric. This requires the entire garment to be woven as one piece. This is a detriment to mass production and increases the cost and manufacturing time of the garment. The fabric might also contain discrete wires woven into the fabric or attached to the outside of the fabric. This method works well with all of these.

Most mass produced garments today are produced in cut sections and the sections are sewn together. It would be very advantageous to be able to cut and sew the fabrics having electrically conductive yarns like other garments but the cutting operation disrupts the circuit and when sewed together, there is no guarantee that the seam sewing operation will repair the rift in the conductive path.

Thus, there is a need for an inexpensive, easy to apply connection to allow a “bridge” or “connection” from one conductive path to its counterpart on an adjacent piece of fabric. Furthermore, there is a need for this bridge element to be small, rugged and impervious to wide temperature ranges. The garment can be worn in extreme environments plus the garment has to sustain machine washing and drying.

It is possible to hand sew conductive “bridges” with the same conductive material but the economy and ruggedness is questionable.

The conductive yarns produced today can be electrically and mechanically attached to each other by soldering (in some cases), mechanically clamping, riveting or spot welding. These methods are not always reliable, or small, or rugged.

### SUMMARY OF THE INVENTION

An aspect of the present invention is to provide electrical connectors to conduct across separate pieces of conductive fabric sections.

In one aspect of the invention a method of joining two different conductive elements which are each attached to a fabric is disclosed. A heat stacked stud is pressed through the two different conductive elements. The heat stacked stud is to join the two conductive elements.

Still other advantages of embodiments according to the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### BRIEF DESCRIPTION OF THE DRAWINGS

The present invention is illustrated by way of example, and not by limitation, in the Figures of the accompanying drawings, wherein elements having the same reference numeral designations represent like elements throughout and wherein:

FIG. 1(a) is a perspective view of a heat stake stud;

FIG. 1(b) is a side view of the heat stake stud;

FIG. 1(c) is a side view of the heat stake stud placed into a shaped washer;

FIG. 1(d) is a side view of the heat stake stud placed through two conductive yarn traces;

FIG. 1(e) is a side view of the pierced heat stake stud of FIG. 1d after it has been heated and compressed with the tool shown in dotted lines in FIG. 1d;

FIG. 1(f) is a side view of the pierced heat stake stud compressed with a shaped washer;

FIG. 2 is a side view illustrating a tool tip (top) and a tool tip (bottom);

FIG. 3 is a perspective view illustrating a bridge having two heat stake studs for connecting a sewn seam of two fabrics;

FIG. 4 is a side view of a heat stake stud and a complementary washer before being compressed;

FIGS. 5 and 6 are photos showing two dissimilar fabrics being connected together using two heat stake studs.

### DETAILED DESCRIPTION OF THE INVENTION

There exists in the prior art, a process called “heat staking”. This requires a special machine, which applies heat and pressure at the same time to bond two pieces of material together. The materials can be dissimilar.

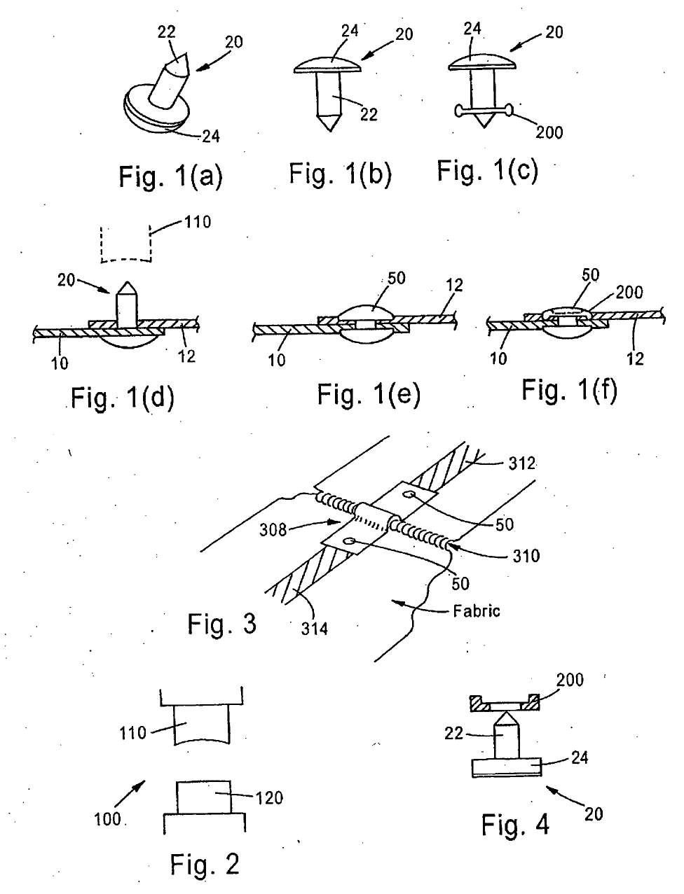

The present invention utilizes the heat staking process in a configuration to join two conductive yarn traces 10, 12 (see FIGS. 1(a)-(f)) or pads by piercing them with a thermo plastic stud 20 (FIGS. 1(a)-(c)) shaped somewhat like a rivet with a pointed post 22 to pierce the fabrics 10, 12 (FIG. 1). Although the post 22 is shown as pointed, it can be any desired shape. The stud 20 also has a cylindrical post 22 and a head 24. Although shown with a cylindrical post 22 and round head 24, these heads and posts can be any shape that can be “heat staked”. The stud 20 can have one or more posts 22 (FIG. 4). One post 22 is shown for simplicity. A properly designed tool 100 (FIG. 2 shows a typical tool) will then be lowered to meet the pointed tip and using the proper heat and proper compression will join the two fabric pieces 10, 12 mechanically and electrically. The heat and compression formed stud 50 (FIGS. 1(e) and 1(f)) will provide mechanical strength and actually seal the connection if so required. (FIG. 3)

As shown in FIG. 2 and in dotted lines in FIG. 1(d), a tool tip top 110 will be brought into contact with the pointed post 22 and a tool tip bottom 120 would be brought into contact with the head 24.

The tool 100 could be shaped such that the heat staked stud 50 (FIG. 1(f)) could have embossed identities or decorations so that they would become part of the garment design. The heat stake stud 50 can also have a complementary washer 200 to trap the melt and provide additional mechanical advantage. (FIGS. 1(c) and 4)

Thus, if it were desired that any number of woven traces were to bridge a sewn seam 308 of two fabrics 302, 304, (like a sleeve to a torso) a similar section of fabric with the same sewn grid could be used to bridge the seam much like an epaulet. (FIG. 3) Using the heat staking studs 20 (shown as staked in FIG. 3), it would be a simple process using a conductive flexible bridge 308 to connect conductive strips 312, 314 over a sewn seam 310 to join the two fabrics 302,301 such that two conductive strips 313, 314 would be contiguous. The two conductive strips can either be discrete wires, conductive traces or part of the fabric. These conductive strips can be attached in any known manner to the fabric.

Thus, it can be appreciated that a method and apparatus has been described that provides electrical connection across separate pieces of conductive fabric sections.

FIG. 4 is a side view of a heat stake stud and a complementary washer before being compressed;

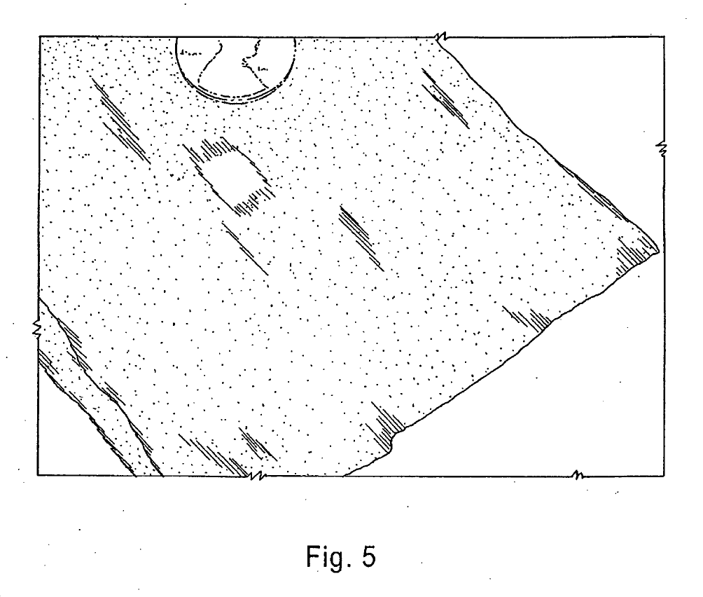

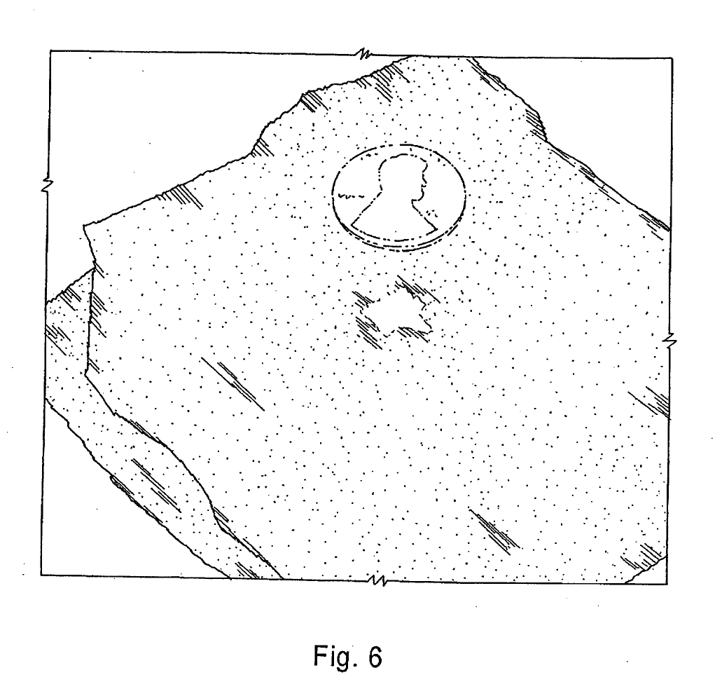

FIGS. 5 and 6 are photos showing two dissimilar fabrics being connected together using two heat stake studs.

In addition it is possible to heat stake discrete wires to conductive yarns such that a signal or voltage can be introduced or extracted from the circuits in the fabric. These discrete wires or conductive yarn traces can also be joined together in a single piece of fabric.

Another iteration of the present invention would be to produce the heat staking studs from an electrically conductive thermal plastic thus providing additional paths for electric current if there is any concern about a sole compression connection. Also, the heat stacked studs can be made of conductive plastic to further guarantee the electrical connection at all times due to reduncy.

Another iteration of the present invention would be to include a thin metal disc between the conductive strips 312, 314 or traces and the heat stake stud 50 in order to further guarantee a good electrical connection.

Proper selection of the thermal plastic stud material will allow the garment to be machine washed and dried without jeopardizing the connections. In addition, proper selection of the thermal plastic stud material will insure that the fabric will not melt during this attachment process.

The plastic studs can be supplied in any color in the event coloration is required for style or camouflage.

As the heat staking process is fast, and the mass of the stud is so small, the stud cools very rapidly, and operators will not sustain burns during the installation process.

As the implementation of the conductive yarns can be controlled within tight tolerances in a pattern in a fabric, this method of joining can be automated.

The resultant heat staked stud can be shaped to minimize protrusion or to eliminate sharp edges. It could be small in diameter and thickness such that the wearer would not be conscious of its presence.

As the joining member is plastic, it is possible to remove the stud by clipping it off and detaching the two fabric segments.

It would be possible to join traces with small spacing—example 0.100 inches or less.

The present invention also advantageously is permanent in nature but is removable and replaceable if the need arises. The present invention also advantageously can be used to shape the staked studs into desired shapes, can be nearly undetectable, and can be very low profile. It should also be apparent that the present invention is particularly suitable for automated mass production.

Thus, it can be appreciated that a method and apparatus has been described that provides electrical connection across separate pieces of conductive fabric sections.

It will be readily seen by one of ordinary skill in the art that embodiments according to the present invention fulfill many of the advantages set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A method to join two different conductive elements which are each attached to a fabric, comprising the steps of:
pressing a heat staked stud through the two different conductive elements; and
heat staking the stud to join the two conductive elements.

2. The method of claim 1, wherein the two different conductive elements are each attached to different pieces of fabric and two pieces of fabric having these traces are to be joined by sewing into a garment.

3. The method of claim 1, further comprising placing a metal washer next to a post of the stud mechanically grip and seal the connection.

4. The method of claim 1, wherein the conductive elements are discrete wires.

5. The method of claim 1, are wires woven into fabric or fabrics having either conductive traces or discrete wires, woven into, or applied to, or loose for introduction or extraction of signals or voltage.

6. The method of claim 1, wherein the stud is compressed and melts and forms a head opposite a head of the stud.

7. The method of claim 1, wherein the stud is made of plastic.

8. The method of claim 7, wherein the plastic is electrically conductive.

9. The method of claim 1, wherein the conductive elements are colored, and/or one embossed to match or fit a fabric design.

10. The method of claim 1, wherein the conductive elements are made of conductive plastic.

11. The method of claim 2, further comprising placing a conductive bridge over sewn or glued seams which secure the two pieces of fabric together.
